(19) United States
(12) Patent Application Publication
(10) Pub. No.: US 2026/0023205 A1
(43) Pub. Date: Jan. 22, 2026

(54) OPTICAL MODULATOR AND OPTICAL DEVICE

(71) Applicant: HON HAI PRECISION INDUSTRY CO., LTD., New Taipei (TW)

(72) Inventor: YU-FONG YU, New Taipei (TW)

(21) Appl. No.: 19/259,332

(22) Filed: Jul. 3, 2025

(30) Foreign Application Priority Data
Jul. 17, 2024 (CN) 202410958922.7

(51) Int. Cl. G02B 5/30

(52) U.S. Cl. CPC G02B 5/3025

(57) ABSTRACT

An optical modulator includes a substrate and a modulation module. The modulation module includes a plurality of modulation unit blocks on a surface of the substrate. The plurality of modulation unit blocks is spaced apart from each other and arranged irregularly. The modulation module is configured to change a phase and a polarization state of light. An optical device including the optical modulator is also provided.

### FIELD

The subject matter herein relates to a field of laser radar technology, particularly relates to an optical modulator and an optical device having the optical modulator.

### BACKGROUND

In a laser radar transmission system, an optical modulator having periodic arrangement of modulation units are mostly used. The laser will interfere when passing through the modulation units arranged periodically. The interfered laser usually has a main lobe and side lobes. The side lobes may disperse some energy of the main lobe, and can affect the energy of the main lobe in practical applications. The side lobes may not only lead to insufficient light intensity in the main lobe, but also enlarge a size of a laser spot, thereby affecting an overall performance of the laser radar. At present, the above described effects are countered by enhancing a light source power of the laser radar system, thereby increasing an output light energy. However, this method requires a higher power and may cause difficulty in heat dissipation. Another method is to add plano convex lenses to reduce a divergence angle of the beam, make the beam more concentrated, and achieve increased light energy of the main lobe. However, the added plano convex lenses may cause a loss of light intensity.

Therefore, there is room for improvement in the art.

### BRIEF DESCRIPTION OF THE DRAWINGS

Implementations of the present technology will now be described, by way of embodiments only, with reference to the attached figures.

FIG. 1 is a schematic view of an optical modulator according to a first embodiment of the present disclosure.

FIG. 2 is a schematic view of an optical modulator according to a second embodiment of the present disclosure.

FIG. 3 is a schematic view of an optical modulator according to a third embodiment of the present disclosure.

FIG. 4 is a top view of the optical modulator shown in FIG. 3.

FIG. 5 is a schematic view of different shapes of modulation units.

FIG. 6 is a schematic view showing a positional relationship between a substrate and the modulation units in an embodiment of the present disclosure.

FIG. 7 is a schematic view showing a positional relationship between the substrate and the modulation units in another embodiment of the present disclosure.

FIG. 8 is a schematic view of a driving module according to an embodiment of the present disclosure.

FIG. 9 is a view showing a far-field diffraction pattern of a comparative example.

FIG. 10 is a view showing a far-field diffraction pattern of an embodiment of the present disclosure.

FIG. 11 is a schematic view of an optical device according to an embodiment of the present disclosure.

FIG. 12 is a schematic view of a laser radar according to an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

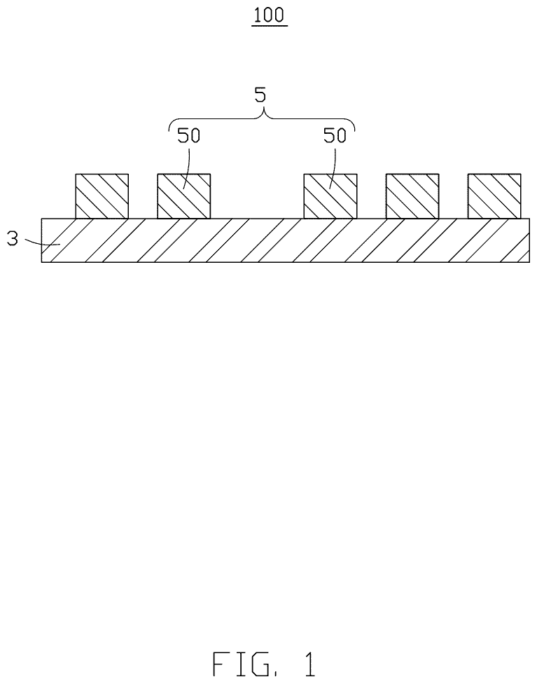

FIG. 1 illustrates an optical modulator 100. The optical modulator 100 includes a substrate 3 and a modulation module 5 on the substrate 3. The modulation module 5 includes a plurality of modulation unit blocks 50 spaced apart from each other and arranging irregularly. All of the modulation unit blocks 50 are set on a same surface of the substrate 3. The modulation module 5 is used to change a phase and a polarization state of light projected on the modulation module 5.

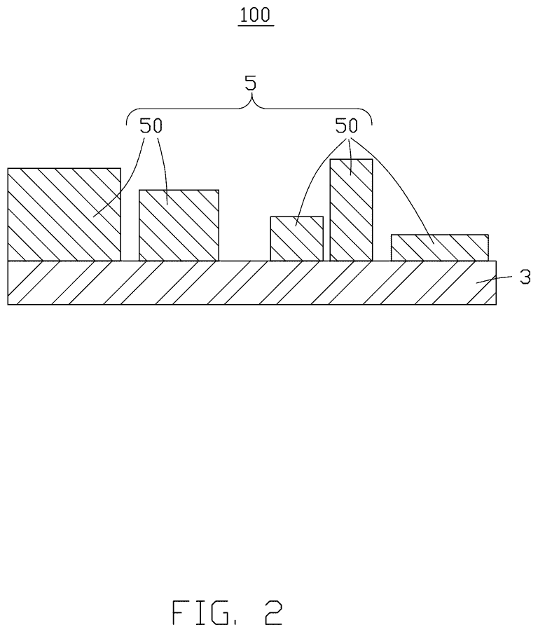

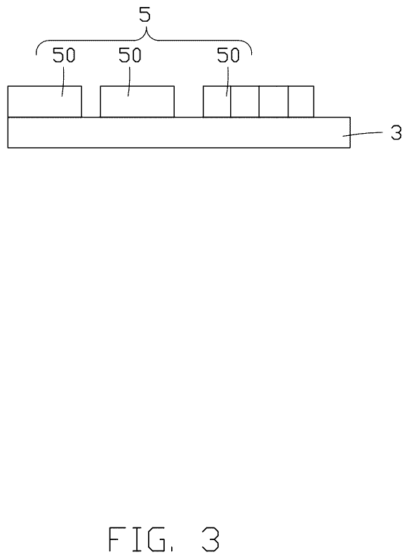

As shown in FIG. 2, the modulation unit blocks 50 include at least two modulation unit blocks 50 having different sizes or different shapes. As shown in FIG. 3, the modulation unit blocks 50 arranging irregularly may also include at least two modulation unit block 50 having different sizes and different shapes. In addition, please refer to FIG. 1 again, the modulation unit blocks 50 also includes at least two modulation unit blocks 50 having a same size and a same shape arranged irregularly.

The optical modulator 100 provided in embodiments of the present disclosure can not only change a phase and polarization state of the incident light, but also solve a problem of non-concentration of light energy after emission by setting irregularly arranged modulation unit blocks 50 having the same size and the same shape on the same side of the substrate 3, or setting at least two modulation unit blocks 50 of different sizes and/or shapes. This is conducive to improving the light energy of the main lobe and reducing the light energy of the side lobes, and can conveniently achieve the distribution and adjustment of light energy, thereby controlling the emission amplitude of light.

In this embodiment, the substrate 3 is made of silicon. The use of silicon as the material of the substrate 3 has advantages of high conductivity and low cost. Due to the fact that the material of substrate 3 depends on an overall application environment of the light modulator 100, in other embodiments, the substrate 3 can also be made of indium phosphide, silicon nitride, or silicon-based photoelectrons, and this disclosure does not limit it.

An arrangement of the modulation unit blocks 50 on the substrate 3 is irregular. In this embodiment, the material of the modulation unit block 50 can be a metal material having a high conductivity and can cause surface plasma excitation. For example, at least one metal such as copper (Cu), aluminum (Al), nickel (Ni), iron (Fe), or an alloy containing at least one of the above mentioned metals. In addition, the modulation unit block 50 can also be made of commonly used linear electro-optic effect materials, such as potassium dihydrogen phosphate (KDP), ammonium dihydrogen phosphate (ADP), lithium niobate (LiNbO), lithium iodate (LiIO), and other crystals that do not have central symmetry. In other embodiments, the modulation unit block 50 can also be made of piezoelectric materials, such as quartz crystal, lithium galliate, lithium germanate, titanium germanate, and iron transistor lithium niobate, lithium tantalate, etc. The material of the modulation unit block 50 is not limited to thermo optic material, piezoelectric material or electro-optic material. In the present embodiment, the material of the modulation unit blocks 50 are the same. In other embodiments, the materials of the modulation unit blocks 50 are different.

The modulation unit block 50 is formed by low-temperature deep etching, and a mask is used for local etching during an etching process. In this embodiment, the mask may be made of various etching mask material, such as polymer, Cr, silicon dioxide and Cr-homopolymer. Due to the limitations of Cr and silicon dioxide direct hard masks, which are key factors in achieving aspect ratios, and the etching selectivity affecting the limitations of the mask. That is, the polymer mask has a same high selectivity as Cr, reducing excessive under cutting introduced by the direct hard mask. By optimizing the etching parameters, each modulation unit block 50 is formed on a surface of the substrate 3. In other embodiments, other methods for forming the modulation unit blocks 50 can also be used.

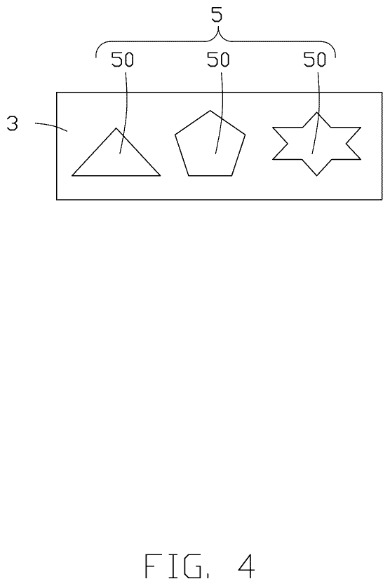

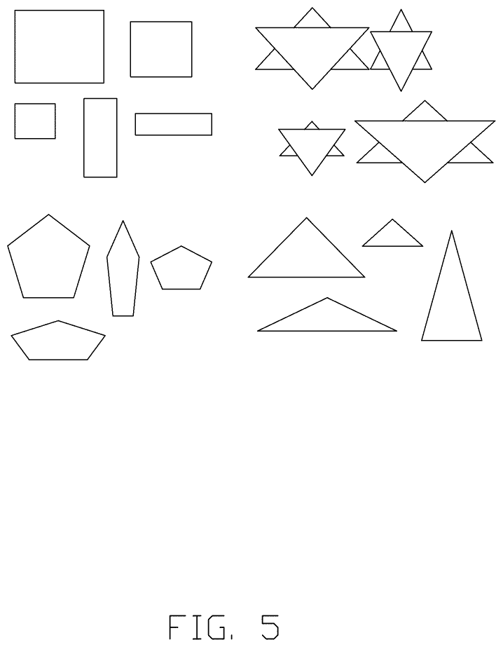

As shown in FIG. 4 and FIG. 5, a projection shape of each modulation unit block 50 on the substrate 3 includes one or any combination of a rectangle, a square, a triangle, a star, a pentagon, a polygon, an arc, and a circle. Each modulation unit block 50 is columnar. A resonance wavelength, a resonance wavelength width, reflection characteristics, absorption characteristics, and transmission characteristics of light passing through the modulation unit blocks 50 can be changed according to a structure, a type, and an arrangement of the modulation unit blocks 50. The optical modulator 100 can, for example, change polarization characteristics (circular polarization, linear polarization, etc.) of the incident light source, alter a strength of the main peak energy, and even achieve phase deviation and make it have a characteristic of Epsilon near zero (ENZ). The characteristic of ENZ refers to a tendency of a real part of the dielectric constant approaching zero (ε˜0) within a specific wavelength range. Based on a change in material refractive index Δn=Δε/(2√ε), when & approaches zero, theoretically a finite change in dielectric constant can result in a significant change in refractive index, leading to a series of nonlinear optical phenomena. The ENZ wavelength range was first proposed in metamaterials. Therefore, the optical modulator 100 having different characteristics can be manufactured by controlling the structure, type, and arrangement of the modulation unit blocks 50.

In this embodiment, both a height and a width of each modulation unit block 50 are less than or equal to 1 μm. For example, the height and the width of each modulation unit block 50 may be within any of ranges of 0.1-0.3 μm, 0.3-0.5 μm, and 0.5-0.99 μm. Through experiments, it was found that when parameters of each modulation unit block 50 are controlled within above ranges, an overall size of the optical modulator 100 is not affected without changing its performance parameters. A spacing between adjacent two modulation unit blocks 50 is less than or equal to 1 μm. For example, the spacing between adjacent two modulation unit blocks 50 is within any of ranges of 0.1-0.3 μm, 0.3-0.5 μm, and 0.5-0.99 μm. When the spacing between adjacent two modulation unit blocks 50 is too great, it will cause the overall volume of the optical modulator 100 to be too large, increasing a difficulty of processing.

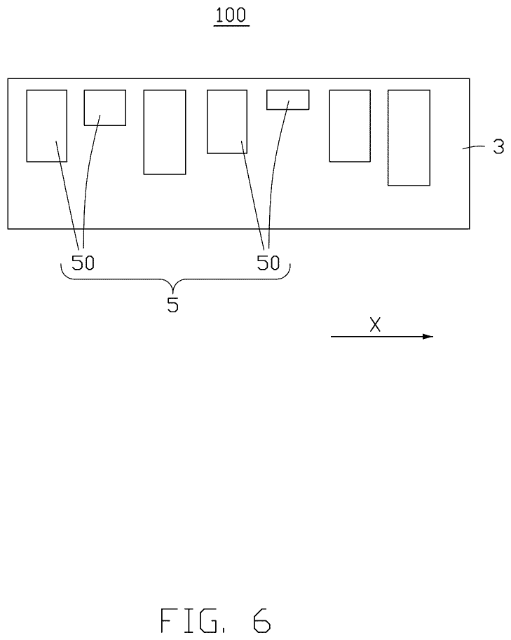

As shown in FIG. 6, the modulation unit blocks 50 are arranged along a first direction X on the substrate 3. The first direction X is parallel to the substrate 3. All of the modulation unit blocks 50 are set in at least one row parallel to the first direction X on a surface of the substrate 3.

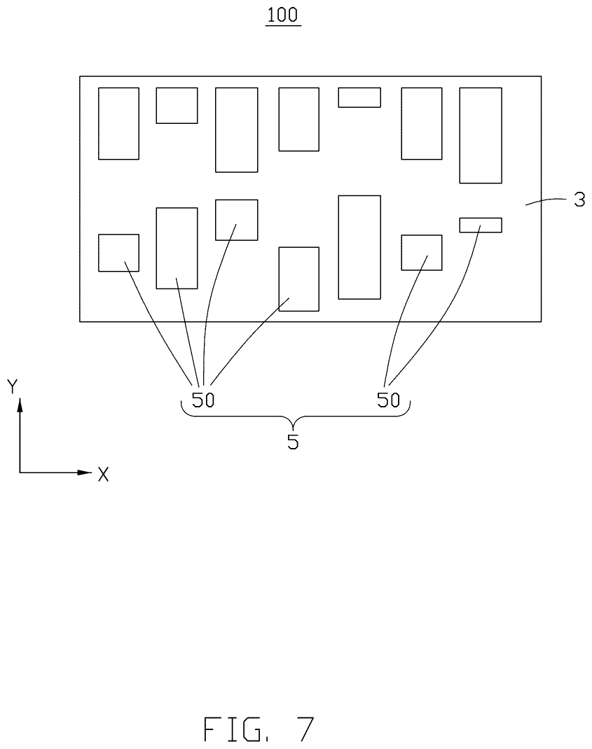

As shown in FIG. 7, the modulation unit blocks 50 are arranged along a second direction Y on the substrate 3. The second direction Y is perpendicular to the first direction X. All of the modulation unit blocks 50 are set in several columns parallel to the second direction Y on a surface of the substrate 3. The different arrangement of modulation unit blocks 50 on the surface of substrate 3 affects the specific functional effects. When the light beam passes through the optical modulator 100, the different arrangement of the modulation unit blocks 50 affects turning of the light beam in different directions. Therefore, the present disclosure does not limit the specific arrangement of the modulation unit blocks 50 on the substrate 3.

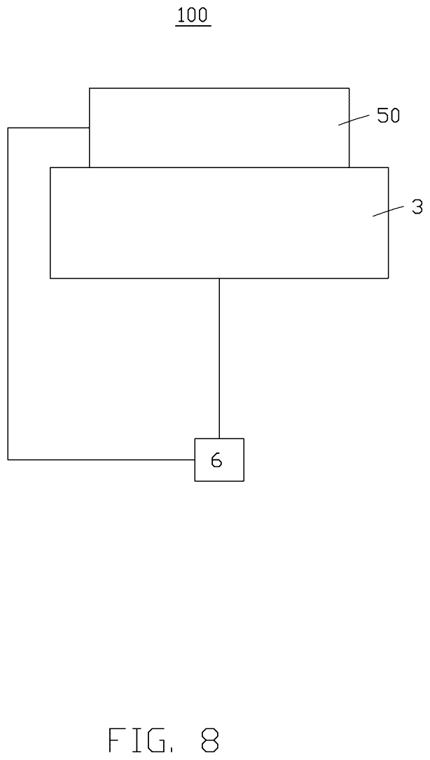

Please refer to FIG. 8, the optical modulator 100 further includes a driver 6. The driver 6 is electrically connected to the substrate 3 and the modulation unit blocks 50, respectively. The driver 6 is used to drive the deviation angle and various modulation characteristics of modulated light L1 passing through the optical modulator 100. The driver 6 applies voltage to change a refractive index of the substrate 3, adding additional phase to the light. Finally, light with different phases is radiated through modulation unit blocks 50, achieving beam deflection and scanning.

The optical modulator 100 provided in the embodiments of the present disclosure is advantageous in solving the problem of non-concentration of optical energy after emission, thereby improving the optical energy of the main lobe and reducing the optical energy of the side lobes. It can conveniently achieve the distribution and adjustment of optical energy, thereby controlling the emission amplitude of light.

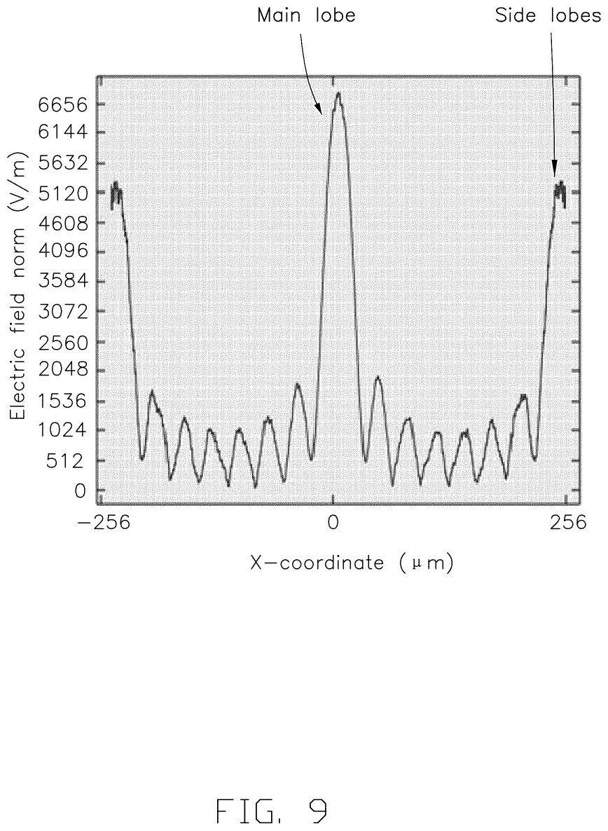

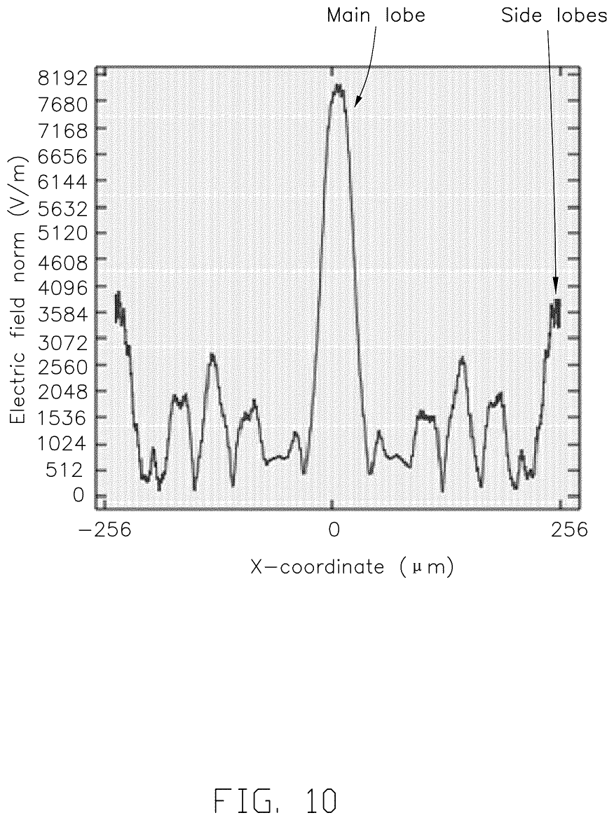

FIG. 9 is a schematic view of distribution of return light by applying a conventional optical modulator. The distribution is a far-field diffraction pattern under uniform beam splitting. FIG. 10 is a schematic view of distribution of return light by applying the optical modulator 100 provided in this disclosure. The distribution is the far-field diffraction pattern under non-uniform beam splitting. Compared with FIG. 9, the sidelobes are significantly suppressed. By optimizing the spacing between modulation unit blocks 50, the coherence condition is disrupted to compress sidelobes and achieve a larger scanning range, achieving the goal of simultaneously optimizing both the grating lobes and sidelobes.

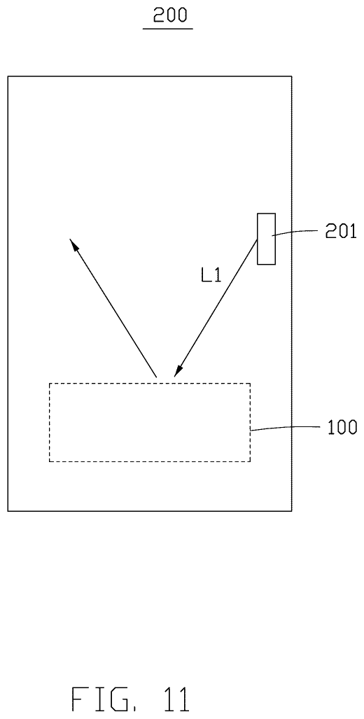

FIG. 11 illustrates an optical device 200. The optical device 200 includes a light source 201 for emitting modulated light L1 and the optical modulator 100 in any of above embodiments. The optical modulator 100 is used to receive the modulated light L1 emitted by the light source 201, change a phase and polarization state of the modulated light L1. The optical device 200 may include a beam steering device. The beam steering device can be applied to any optical device among various optical devices. For example, the beam steering device can be applied to light detection and ranging devices. The light detection and the ranging device can be applied to bicycles, ships, cars, airplanes, etc. In addition, the light detection and ranging device can be used in application fields such as radar, obstacle avoidance, 3D printing, image display, and free space optical communication.

The optical device 200 provided in the embodiments of the present disclosure can easily and conveniently change the phase and polarization state of the incident light by applying the above-mentioned optical modulator 100. It can also help solve the problem of non-concentration of light energy after emission, thereby improving the light energy of the main lobe, reducing the light energy of the side lobe, achieving the distribution and adjustment of light energy, and controlling the emission amplitude of light

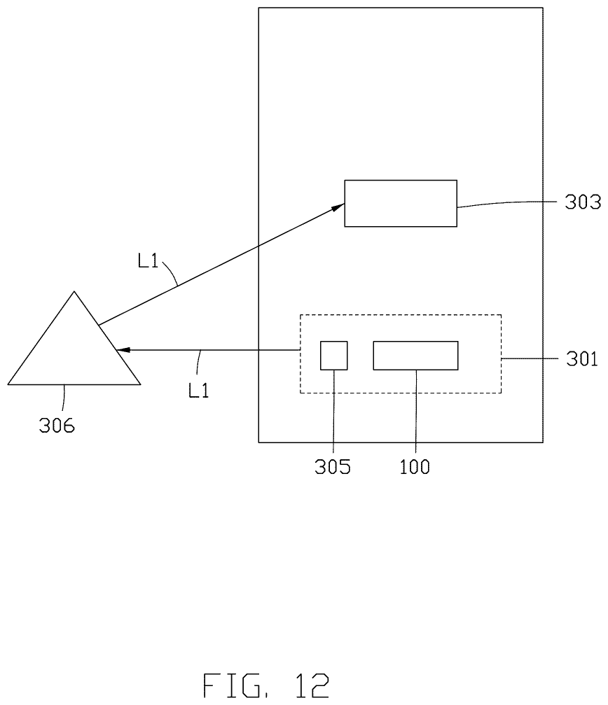

As shown in FIG. 12, in this embodiment, the optical device 200 is a laser radar 300, including a transmitting system 301 and a receiving system 303. The transmission system 301 also includes a collimation module 305 for focusing and collimating the modulated light L1 emitted from the light source 201. The modulated light L1 pass through the optical modulator 100. The phase and polarization state of the modulated light L1 can be changed by using the optical modulator 100, it is beneficial to solve the problem of non-concentration of light energy after emission, thereby improving the light energy of the main lobe and reducing the light energy of the side lobes. This can facilitate the allocation and adjustment of light energy, thereby controlling the emission amplitude of light. The modulated light L1 emitted from the optical modulator 100 is reflected by an external object 306 after being emitted into a free space.

The receiving system 303 is used to receive the modulated light LI reflected back from the free space. The receiving system 303 may include an optical amplifier (not shown), a photoelectric converter (not shown), a transimpedance amplifier (not shown), and an analog-to-digital converter (not shown). The receiving system 303 amplifies the modulated light L1 and converts the modulated light L1 from an optical signal to an electrical signal through a photoelectric converter, where the electrical signal is a current signal. The current signal is then passed through the transimpedance amplifier, the transimpedance amplifier is used to receive the current signal transmitted by the photoelectric converter and amplify the current signal into a voltage signal. The voltage signal is finally passed through the analog-to-digital converter 313, which is used to convert continuous analog signals into discrete digital signals, facilitating signal processing and data conversion, and facilitating computer control and calculation.

The laser radar 300 provided in the embodiments of the present disclosure, by applying the above-mentioned optical modulator 100, can not only change the phase and polarization state of the incident light, but also solve the problem of non-concentration of light energy after emission, thereby improving the light energy of the main lobe and reducing the light energy of the side lobes. It can conveniently achieve the distribution and adjustment of light energy, thereby controlling the emission amplitude of light.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An optical modulator comprising:
a substrate; and
a modulation module comprising a plurality of modulation unit blocks on a surface of the substrate, wherein the plurality of modulation unit blocks is spaced apart from each other and arranged irregularly, the modulation module is configured to change a phase and a polarization state of light projected on the modulation module.

2. The optical modulator of claim 1, wherein the plurality of modulation unit blocks comprises at least two modulation unit blocks having different sizes; or
the plurality of modulation unit blocks comprises at least two modulation unit blocks having different shapes; or
the plurality of modulation unit blocks comprises at least two modulation unit blocks having different sizes and different shapes.

3. The optical modulator of claim 1, wherein the plurality of modulation unit blocks are made of different materials.

4. The optical modulator of claim 1, wherein each of the plurality of modulation unit blocks is columnar; a projection shape of each of the plurality of modulation unit blocks on the substrate comprises one or any combination of a rectangle, a square, a triangle, a star, a pentagon, a polygon, an arc, and a circle.

5. The optical modulator of claim 1, wherein each a height and a width of each of the plurality of modulation unit blocks is less than or equal to 1 μm.

6. The optical modulator of claim 1, wherein a spacing between adjacent two of the plurality of modulation unit blocks is less than or equal to 1 μm.

7. The optical modulator of claim 1, wherein the plurality of modulation unit blocks is arranged in at least one row parallel to a first direction on the substrate.

8. The optical modulator of claim 7, wherein the plurality of modulation unit blocks is further arranged in at least one column parallel to a second direction, the second direction is perpendicular to the first direction.

9. An optical device comprising:
a light source configured for emitting modulated light; and
an optical modulator configured for receiving the modulated light, the optical modulator comprising:
a substrate; and
a modulation module comprising a plurality of modulation unit blocks on a surface of the substrate, wherein the plurality of modulation unit blocks is spaced apart from each other and arranged irregularly, the modulation module is configured to change a phase and a polarization state of light projected on the modulation module.

10. The optical device of claim 9, wherein the optical device is a laser radar, the laser radar comprises a transmitting system and a receiving system; the transmitting system is configured for receiving the modulated light emitted from the optical modulator and emitting the modulated light toward a free space, the receiving system is configured for receiving the modulated light reflected back from the free space.

11. The optical device of claim 9, wherein the plurality of modulation unit blocks comprises at least two modulation unit blocks having different sizes; or
the plurality of modulation unit blocks comprises at least two modulation unit blocks having different shapes; or
the plurality of modulation unit blocks comprises at least two modulation unit blocks having different sizes and different shapes.

12. The optical device of claim 9, wherein the plurality of modulation unit blocks are made of different materials.

13. The optical device of claim 9, wherein each of the plurality of modulation unit blocks is columnar; a projection shape of each of the plurality of modulation unit blocks on the substrate comprises one or any combination of a rectangle, a square, a triangle, a star, a pentagon, a polygon, an arc, and a circle.

14. The optical device of claim 9, wherein each a height and a width of each of the plurality of modulation unit blocks is less than or equal to 1 μm.

15. The optical device of claim 9, wherein a spacing between adjacent two of the plurality of modulation unit blocks is less than or equal to 1 μm.

16. The optical device of claim 9, wherein the plurality of modulation unit blocks is arranged in at least one row parallel to a first direction on the substrate.

17. The optical device of claim 16, wherein the plurality of modulation unit blocks is further arranged in at least one column parallel to a second direction, the second direction is perpendicular to the first direction.
